(19) United States
(12) Patent Application Publication
(10) Pub. No.: US 2017/0309087 A1
(43) Pub. Date: Oct. 26, 2017

(54) Method for Enabling a Trained Professional to Perform a Remote Inspection of a Vehicle

(71) Applicant: Thomas Allen, Schnecksville, PA (US)

(72) Inventor: Thomas Allen, Schnecksville, PA (US)

(21) Appl. No.: 15/492,882

(22) Filed: Apr. 20, 2017

Related U.S. Application Data
(60) Provisional application No. 62/325,453, filed on Apr. 20, 2016.

(51) Int. Cl. G07C 5/00; G09B 19/00; G09B 5/02

(52) U.S. Cl. CPC G07C 5/008; G09B 5/02; G09B 19/003

(57) ABSTRACT

A method for enabling a trained professional to perform a remote inspection of a vehicle uses a trained professional, an assistant, a remote server, and PC devices. The trained professional has a unique account and acts as a moderator for the vehicle inspection. The assistant has a unique account that is used to communicate with the moderator account. The moderator account initiates the vehicle inspection process by transmitting a communication request to the assistant account. Once the assistant account accepts the communication request, the moderator is able to select the desired vehicle inspection process to execute. The moderator account then directs the assistant account to perform the necessary actions to find all damage indicators on the vehicle being inspected. The remote server then compiles the damage indicators and generates a vehicle inspection report.

The current application claims a priority to the U.S. Provisional Patent application Ser. No. 62/325,453 filed on Apr. 20, 2016.

### FIELD OF THE INVENTION

The present invention relates generally to a method of performing a vehicle inspection. More specifically, the present invention relates to a method that enables a trained professional to direct an untrained assistant to execute the necessary steps to perform a vehicle inspection through a software interface.

### BACKGROUND OF THE INVENTION

Inspections to determine vehicle condition, and in particular to determine whether a vehicle body has been the subject of repairs, are important in the market for used vehicles. There is an industry devoted to providing condition information about used vehicles. One aspect of the vehicle inspection industry is performing vehicle inspections and providing the information to collectors of that information. These collectors, in turn, provide that information to prospective vehicle purchasers, vehicle dealers, and others. Conventionally, vehicle inspections are performed by having a trained vehicle inspector visually and physically inspect the vehicle at its location. This process requires an inspector to travel to the location of the vehicle. Conversely, the inspector may require an interested party to move the vehicle to the location of the inspector. In any event, the inspection requires someone to incur the expense and inconvenience of moving the inspector and the vehicle to the same location.

The present invention addresses this issue by providing a method and in which a trained vehicle inspector need not travel see a vehicle, or have the vehicle brought to the inspector's location. Instead, in the method disclosed herein, a trained moderator uses a combination of a video link, a communication link, and a paint-thickness-measurement tool to guide an assistant. The assistant doesn't need to be a trained vehicle inspector, to perform the inspection of the vehicle. The trained moderator guides the assistant during the inspection. In this manner, a credible and reliable inspection may be had without incurring the cost of an inspector traveling to the location of the vehicle or vice versa. An added benefit of the present invention is to provide a method for performing remote inspections that ensures the assistant is not falsifying the results. Because the trained moderator is responsible for directing the assistant and generating the report, the present invention is able to ensure the quality of any vehicle inspection report generated.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing an instance of the present invention where the communication between the moderator account and the assistant account is an audiovisual call.

FIG. 4 is a flowchart describing a process for performing a paint thickness inspection through the present invention.

FIG. 5 is a flowchart describing a process for performing multiple repetitions of the paint thickness inspection through the present invention.

FIG. 6 is a flowchart describing a process for performing a visual inspection through the present invention.

FIG. 7 is a flowchart describing a process for performing multiple repetitions of the visual inspection through the present invention.

FIG. 8 is a flowchart describing a process for capturing pictures of a vehicle and then appending those pictures to a vehicle inspection report through the present invention.

FIG. 9 is a flowchart describing a process for sending the vehicle inspection report to a third-party system through the present invention.

### DETAIL DESCRIPTIONS OF THE INVENTION

All illustrations of the drawings are for the purpose of describing selected versions of the present invention and are not intended to limit the scope of the present invention.

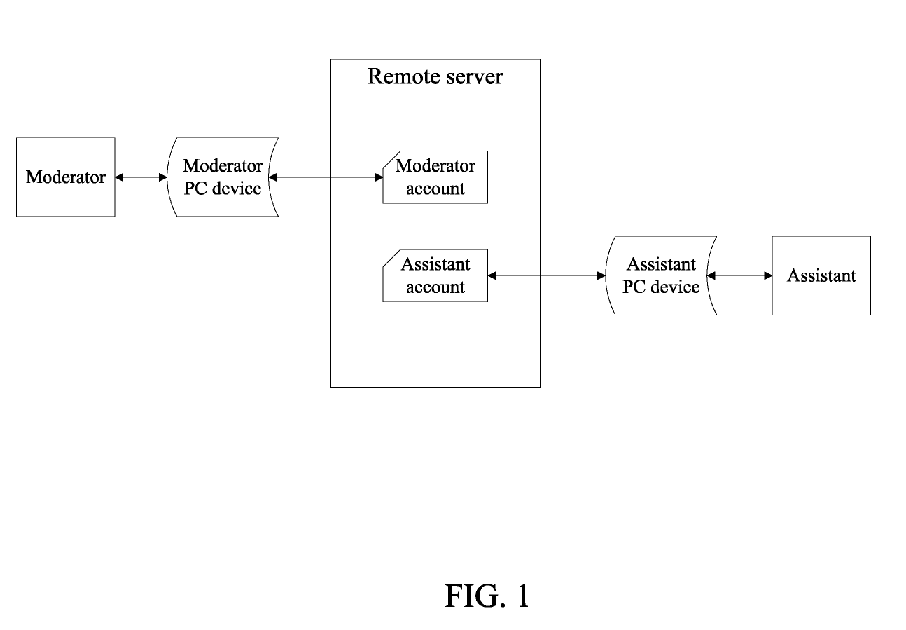

As can be seen in FIG. 1 through FIG. 9, the preferred embodiment of the present invention is a method for enabling a trained professional to perform a remote inspection of a vehicle. The present invention enables a trained professional to perform a vehicle inspection without having to travel to the vehicle's location or moving the vehicle to the trained professional's location. To accomplish this, the present invention employs a video call system to enable the trained professional to interact with an assistant who will perform the vehicle inspection. The trained professional functions as a vehicle inspection moderator who directs the assistant to check for signs of damage at various locations around the vehicle. The present invention is used to record paint thickness measurements made by a paint meter. Additionally, the present invention is used to record notes that indicate visible signs of damage or repair. Once the moderator and assistant have completed the vehicle inspection, the moderator uses the present invention to generate a report that contains analysis of the vehicle's repair history and current physical condition.

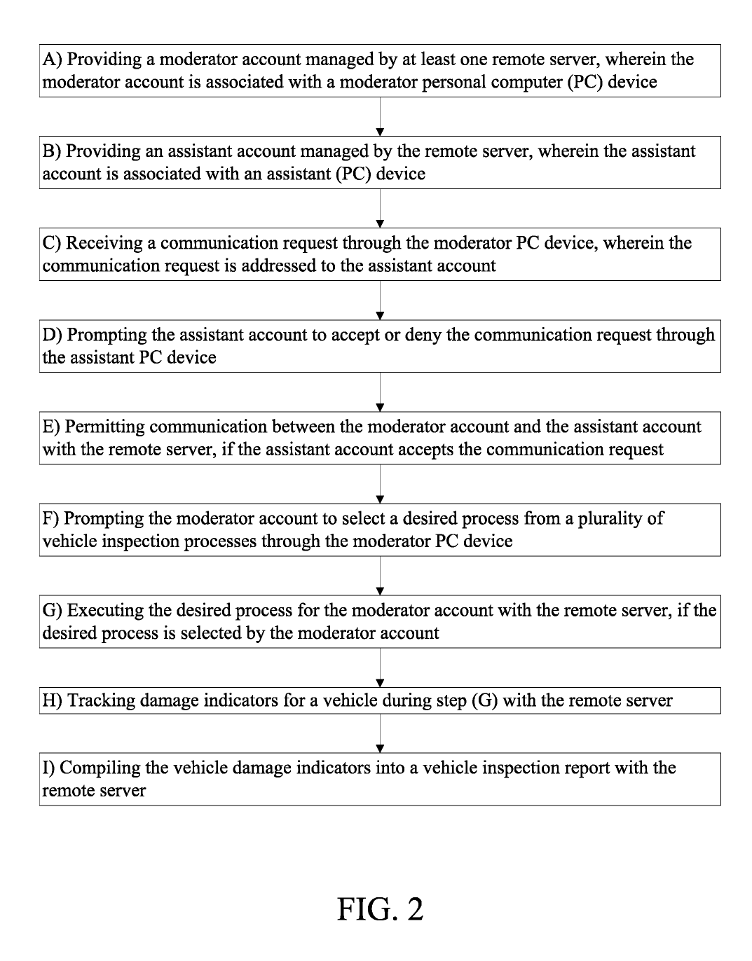

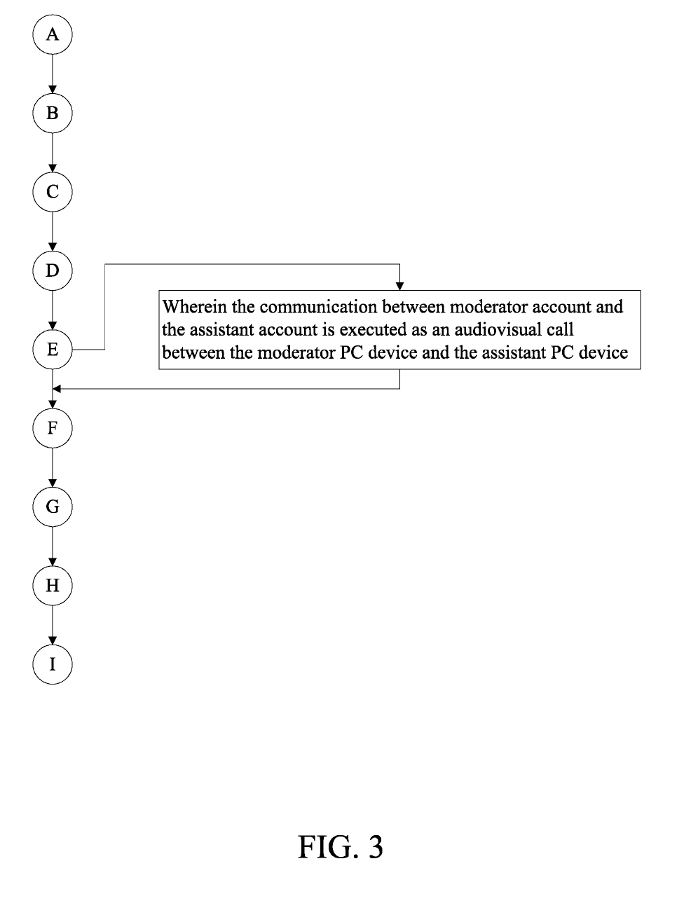

As can be seen in FIG. 2 and FIG. 3, the system used to execute the method of the present invention allows the present invention to manage the vehicle inspection activity of a moderator. Consequently, the present invention identifies the moderator with a unique moderator account. The moderator account allows the present invention to maintain a record of the moderator's clients, credentials, and history. The present invention includes at least one remote server to manage the moderator account which is associated with a moderator personal computer (PC) device (Step A). Similarly, the present invention is used to manage the vehicle inspection activities of an assistant. As a result, the present invention associates the assistant with a unique assistant account. The assistant account is also managed by the remote server and associated with an assistant PC device (Step B). The moderator PC device and the assistant PC device are used to receive input and to relay information between the remote server, the moderator, and the assistant. Additionally, the moderator PC device and the assistant PC device can be, but are not limited to, a smart-phone, a laptop, a desktop, or a tablet PC. The remote server is used to facilitate communication between the moderator account and the assistant account. Furthermore, the remote server is used to execute a number of internal processes for the present invention and is used to store vehicle inspection data.

As can be seen in FIG. 2 and FIG. 3, the overall process followed by the method of the present invention allows the moderator to direct the assistant to perform a vehicle inspection from a remote location. The overall process begins by receiving a communication request through the moderator PC device (Step C). The communication request is a message that the moderator sends to establish a video call with the assistant. Additionally, the communication request is addressed to the assistant account. As such, the communication request contains the contact information required to establish a video call with a specific assistant account. The term “video call” is used hereinafter to refer to real-time and continuous transmission of audio and video data between the moderator PC device and the assistant PC device. The overall process of the present invention continues by prompting the assistant account to accept or deny the communication request through the assistant PC device (Step D). Step D us used to alert the assistant account that the moderator account is ready to begin a vehicle inspection. In the present invention, the moderator and the assistant have previously agreed upon a scheduled time to perform a remote vehicle inspection, prior to Step C. The overall process of the present invention continues by permitting communication between the moderator account and the assistant account with the remote server, if the assistant account accepts the communication request (Step E). This step is used to initiate the video call between the moderator and the assistant. Additionally, the communication between moderator account and the assistant account is executed as an audiovisual call between the moderator PC device and the assistant PC device. Once the connection for the video call is established, the moderator can direct the assistant to adjust the focus of the camera on the assistant PC device that is being used to capture video footage. After the moderator and the assistant agree that the video quality is satisfactory, the remote vehicle inspection can proceed.

As can be seen in FIG. 2, to proceed, the overall process of the present invention continues by prompting the moderator account to select a desired process from a plurality of vehicle inspection processes through the moderator PC device (Step F). The plurality of vehicle inspection processes is a group of possible actions that the moderator can choose from to move forward with the vehicle inspection process. For example, the moderator can select to perform a visual inspection of the vehicle's exterior, a paint thickness inspection using a paint meter, or a mechanical inspection with diagnostic tools. The desired process is the action that the moderator would like to execute to when performing the vehicle inspection. The overall process of the present invention continues by executing the desired process for the moderator account with the remote server, if the desired process is selected by the moderator account (Step G). This step is used to carry out the operations required to perform the desired process of vehicle inspection. The overall process of the present invention continues by tracking damage indicators for a vehicle during Step G with the remote server (Step H). This step is used to record all of the information gathered during the vehicle inspection. The damage indicator is data that indicates some form of irregularity in the vehicle being inspected, such as a note, an image, or a paint thickness reading. The overall process of the present invention concludes by compiling the vehicle damage indicators into a vehicle inspection report with the remote server (Step I). This step is used to generate a report that contains the information gathered during the vehicle inspection process. The moderator is able to send this report to an interested third party or save the report for future reference.

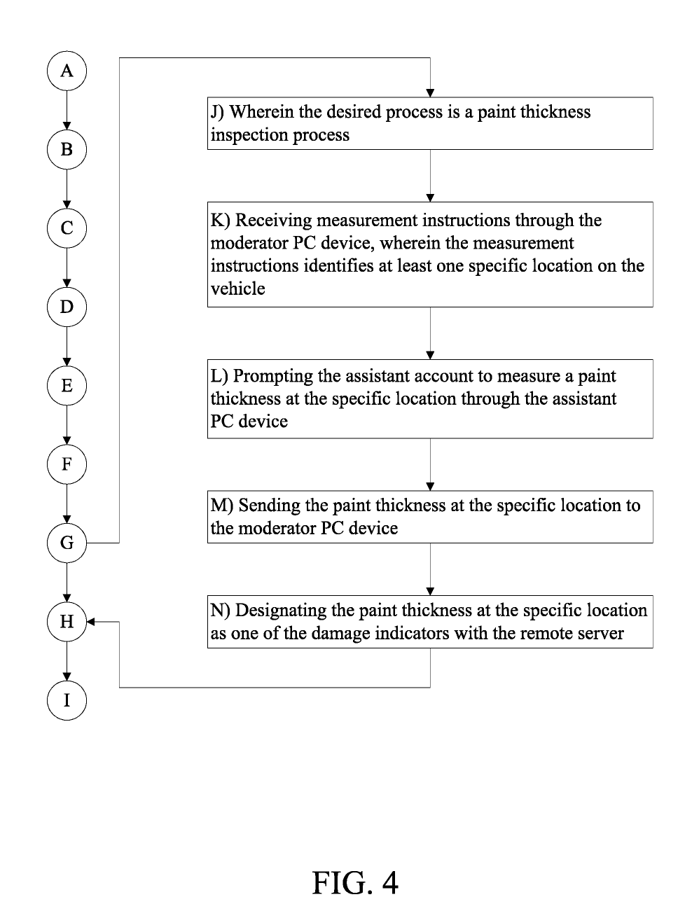

As can be seen in FIG. 4, a sub-process of the present invention is used to enable the moderator and the assistant to perform a paint thickness inspection of the vehicle. This inspection is executed with a paint thickness meter that the assistant uses to determine the thickness of paint at various locations along the vehicle. By assessing the paint thickness at specific locations, the moderator is able to determine if the vehicle has been repainted or repaired. The sub-process begins by the user selecting a paint thickness inspection process as the desired process (Step J). The present invention then executes a series of steps which are directed by the moderator. The sub-process continues by receiving measurement instructions through the moderator PC device (Step K). The measurement instructions are directions that the moderator relays to the assistant so that the assistant can perform the required paint thickness measurement task. Additionally, the measurement instructions identify at least one specific location on the vehicle that the assistant should take a paint thickness measurement. The sub-process continues by prompting the assistant account to measure a paint thickness at the specific location through the assistant PC device (Step L). This step is used to direct the assistant to measure the thickness of paint at the location specified in the measurement instructions. The sub-process continues by sending the paint thickness at the specific location to the moderator PC device (Step M). This step is used to relay the paint thickness measurement taken by the assistant to the moderator. The sub-process concludes by designating the paint thickness at the specific location as one of the damage indicators with the remote server (Step N). This step is used to store the information about the paint thickness of a specific location of the vehicle as an indication of damage to the vehicle.

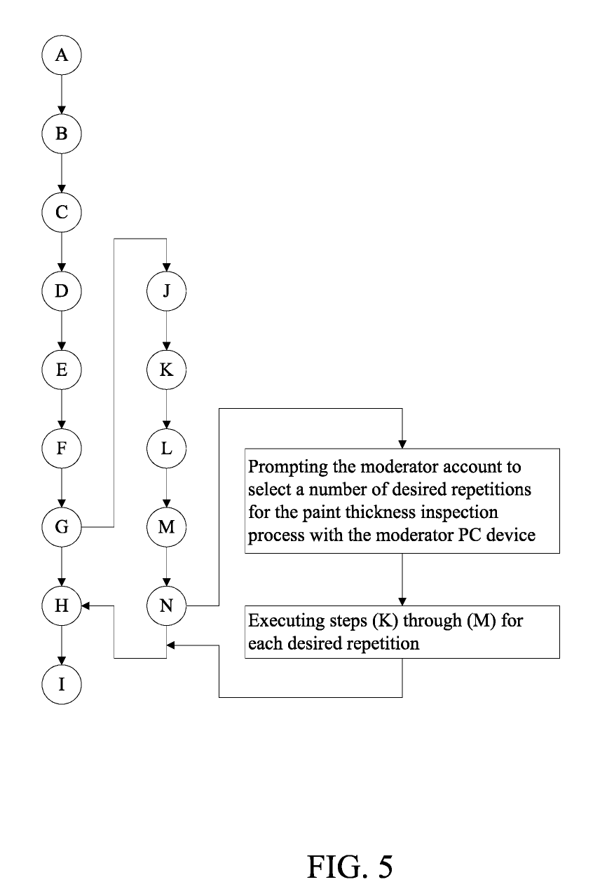

As can be seen in FIG. 5, the present invention enables the moderator to repeat the steps of the paint thickness inspection process as many times as are required to gather paint thickness measurements at every appropriate location on the vehicle. To that end, the paint thickness inspection process contains a sub-process that begins by prompting the moderator account to select a number of desired repetitions for the paint thickness inspection process with the moderator PC device. This step is used to enable the moderator to define the number of location on the vehicle that will be inspected for paint thickness. The sub-process concludes by executing Step K through Step M for each desired repetition. As a result, the paint thickness inspection process concludes when the assistant has taken paint thickness measurements at every location that the moderator deems necessary.

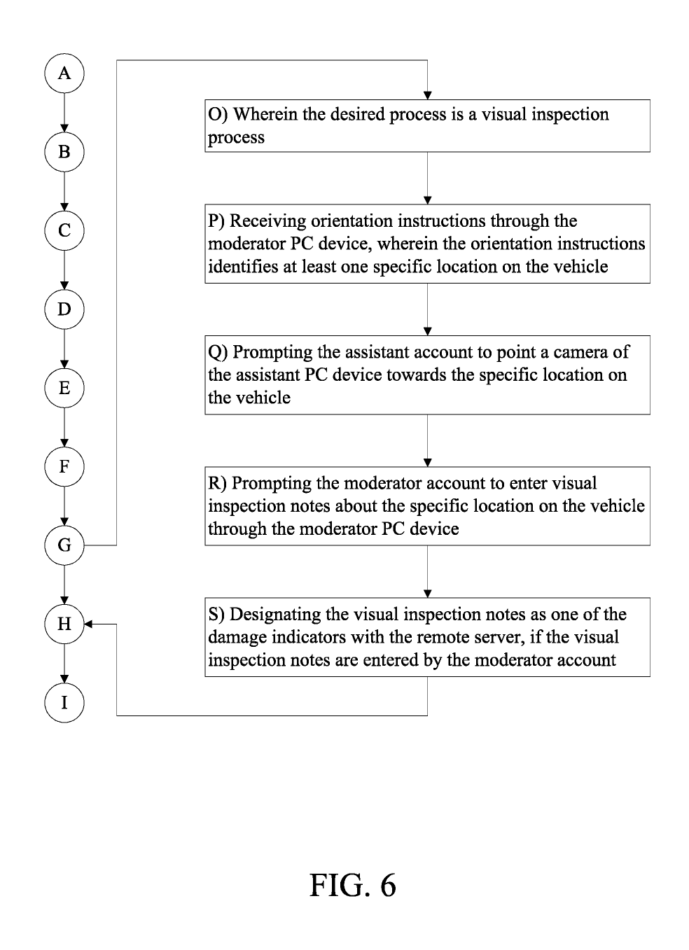

As can be seen in FIG. 6, a separate sub-process of the present invention is used to enable the moderator and the assistant to perform a visual inspection of the vehicle. This inspection is executed by the assistant focusing the camera of the assistant PC device onto various locations along the vehicle. By looking at specific locations of the vehicle, the moderator is able to determine any visible signs of damage. The sub-process begins by the user selecting a visual inspection process as the desired process (Step 0). The present invention then executes a series of steps which are directed by the moderator. The sub-process continues by receiving orientation instructions through the moderator PC device (Step P). The orientation instructions identify a specific location on the vehicle that the assistant should focus the camera on. This step is used to enable the moderator to instruct the assistant to perform a visual inspection of a specific location. The sub-process continues by prompting the assistant account to point a camera of the assistant PC device towards the specific location on the vehicle (Step Q). This step is used to relay the moderator's instruction to the assistant. The assistant is directed to focus the camera of the assistant PC device on a moderator-specified location of the vehicle so that the moderator can determine if there is any visible damage to the vehicle in the specific location. The sub-process continues by prompting the moderator account to enter visual inspection notes about the specific location on the vehicle through the moderator PC device (Step R). This step is used to give the moderator a chance to record any pertinent observations about the specific location of the vehicle being inspected. For example, the moderator would make a note if the bumper of the vehicle is obviously damaged. The sub-process concludes by designating the visual inspection notes as one of the damage indicators with the remote server (Step S). This step is only executed if the moderator makes a visual inspection note about the specific location on the vehicle that is being inspected. This step is used to classify the visual inspection note as one of the damage indicators for the vehicle inspection report.

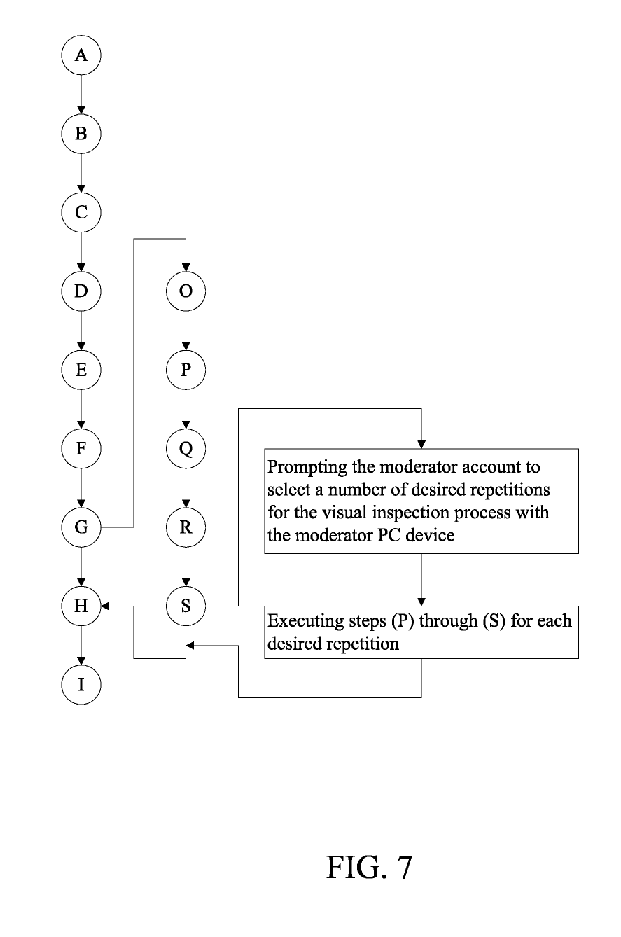

As can be seen in FIG. 7, similar to the paint thickness inspection process, the present invention enables the moderator to repeat the steps of the visual inspection process as many times as are required to check for visible signs of damage or repair at every appropriate location on a vehicle. To that end, the visual inspection process contains a sub-process that begins by prompting the moderator account to select a number of desired repetitions for the visual inspection process with the moderator PC device. This step is used to enable the moderator to define the number of location on the vehicle that will be visually inspected. The sub-process concludes by executing Step P through Step S for each desired repetition. As a result, the visual inspection process concludes when the assistant has visually inspected every location of the vehicle that the moderator deems necessary.

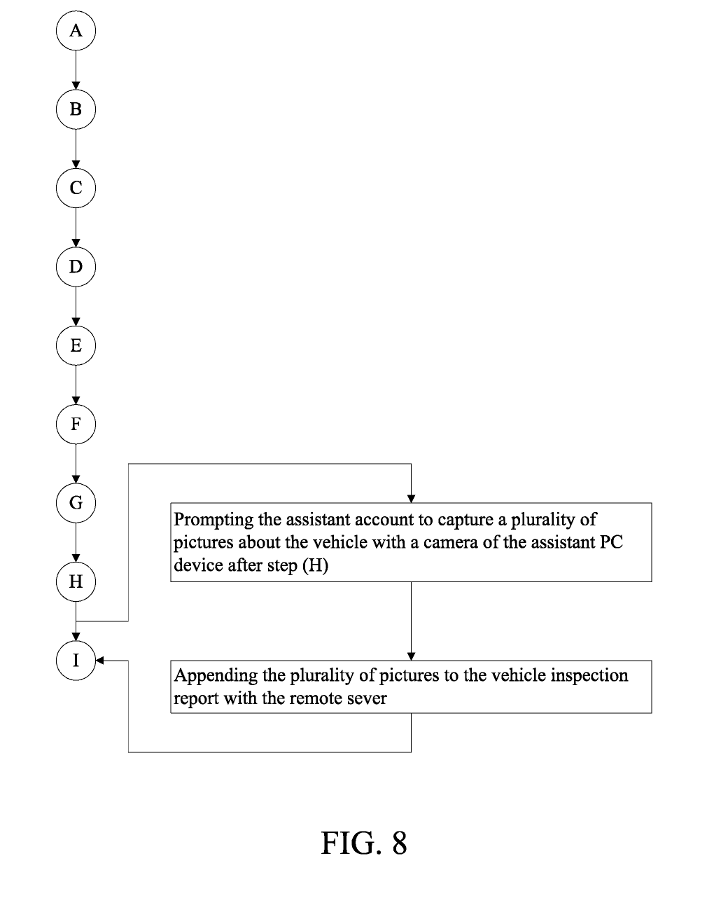

As can be seen in FIG. 8, the method of the present invention is designed with a sub-process that is used to capture high resolution photos of various locations on the vehicle that is being inspected. These photos are used to supplement the information gathered during the paint thickness inspection and the visual inspection. To that end, the sub-process begins by prompting the assistant account to capture a plurality of pictures about the vehicle with a camera of the assistant PC device after Step H. This step is used to enable the assistant to capture as many photos as the assistant feels are necessary to document vehicle damage. The sub-process concludes by appending the plurality of pictures to the vehicle inspection report with the remote server. This step is used to attach the pictures taken by the assistant to the vehicle inspection report being curated by the moderator.

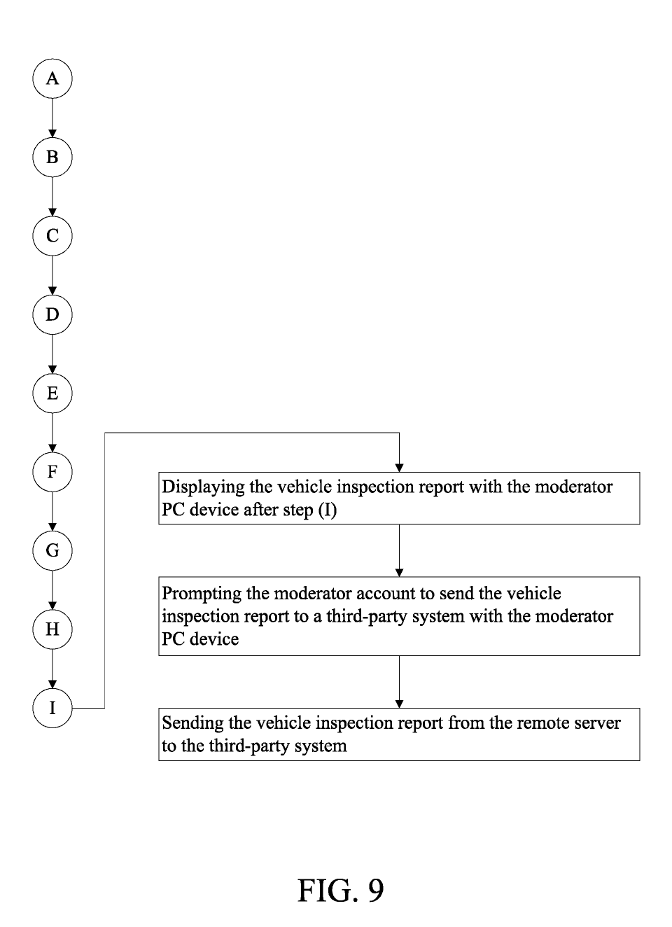

As can be seen in FIG. 9, the method of the present invention is designed with a sub-process that is used to send the completed vehicle inspection report to an interested third party. For example, if a car dealership is interested in selling the vehicle that was inspected, the moderator would send the vehicle inspection report to the car dealership. The sub-process begins by displaying the vehicle inspection report with the moderator PC device after Step I. This step is used to give the moderator a chance to perform a final review of the vehicle inspection report before sending the vehicle inspection report to the interested third party. The sub-process continues by prompting the moderator account to send the vehicle inspection report to a third-party system with the moderator PC device. This step is used to enable the moderator to select the recipient of the vehicle inspection report. The third-party system is an electronic system capable of receiving the vehicle inspection report. The third-part systems can be devices including, but not limited to remote servers, smartphones, PC devices, email clients, and cloud-based datacenters. The sub-process concludes by sending the vehicle inspection report from the remote server to the third-party system. This step transmits the completed vehicle inspection report to the third-party system.

Although the invention has been explained in relation to its preferred embodiment, it is to be understood that many other possible modifications and variations can be made without departing from the spirit and scope of the invention as hereinafter claimed.

What is claimed is:

1. A method for enabling a trained professional to perform a remote inspection of a vehicle comprises the steps of:
(A) providing a moderator account managed by at least one remote server, wherein the moderator account is associated with a moderator personal computer (PC) device;
(B) providing an assistant account managed by the remote server, wherein the assistant account is associated with an assistant PC device;
(C) receiving a communication request through the moderator PC device, wherein the communication request is addressed to the assistant account;
(D) prompting the assistant account to accept or deny the communication request through the assistant PC device;
(E) permitting communication between the moderator account and the assistant account with the remote server, if the assistant account accepts the communication request;
(F) prompting the moderator account to select a desired process from a plurality of vehicle inspection processes through the moderator PC device;
(G) executing the desired process for the moderator account with the remote server, if the desired process is selected by the moderator account;
(H) tracking damage indicators for a vehicle during step (G) with the remote server; and
(I) compiling the vehicle damage indicators into a vehicle inspection report with the remote server.

2. The method for enabling a trained professional to perform a remote inspection of a vehicle as claimed in claim 1, wherein the communication between moderator account and the assistant account is executed as an audiovisual call between the moderator PC device and the assistant PC device.

3. The method for enabling a trained professional to perform a remote inspection of a vehicle as claimed in claim 1 comprises the steps of:
(J) wherein the desired process is a paint thickness inspection process;
(K) receiving measurement instructions through the moderator PC device, wherein the measurement instructions identifies at least one specific location on the vehicle;
(L) prompting the assistant account to measure a paint thickness at the specific location through the assistant PC device;
(M) sending the paint thickness at the specific location to the moderator PC device; and
(N) designating the paint thickness at the specific location as one of the damage indicators with the remote server.

4. The method for enabling a trained professional to perform a remote inspection of a vehicle as claimed in claim 3 comprises the steps of:
prompting the moderator account to select a number of desired repetitions for the paint thickness inspection process with the moderator PC device; and
executing steps (K) through (M) for each desired repetition.

5. The method for enabling a trained professional to perform a remote inspection of a vehicle as claimed in claim 1 comprises the steps of:
(O) wherein the desired process is a visual inspection process;
(P) receiving orientation instructions through the moderator PC device, wherein the orientation instructions identifies a specific location on the vehicle;
(Q) prompting the assistant account to point a camera of the assistant PC device towards the specific location on the vehicle;
(R) prompting the moderator account to enter visual inspection notes about the specific location on the vehicle through the moderator PC device; and
(S) designating the visual inspection notes as one of the damage indicators with the remote server, if the visual inspection notes are entered by the moderator account.

6. The method for enabling a trained professional to perform a remote inspection of a vehicle as claimed in claim 5 comprises the steps of:
prompting the moderator account to select a number of desired repetitions for the visual inspection process with the moderator PC device; and
executing steps (P) through (S) for each desired repetition.

7. The method for enabling a trained professional to perform a remote inspection of a vehicle as claimed in claim 1 comprises the steps of:
prompting the assistant account to capture a plurality of pictures about the vehicle with a camera of the assistant PC device after step (H); and
appending the plurality of pictures to the vehicle inspection report with the remote sever.

8. The method for enabling a trained professional to perform a remote inspection of a vehicle as claimed in claim 1 comprises the steps of:
displaying the vehicle inspection report with the moderator PC device after step (I);
prompting the moderator account to send the vehicle inspection report to a third-party system with the moderator PC device; and
sending the vehicle inspection report from the remote server to the third-party system.
